(19) United States
(12) Patent Application Publication
(10) Pub. No.: US 2026/0140812 A1
(43) Pub. Date: May 21, 2026

(54) SYSTEM AND METHOD FOR AGENTIC ARTIFICIAL INTELLIGENCE BASED ROOT CAUSE ANALYSIS IN HYBRID DISTRIBUTED SYSTEMS

(71) Applicant: Jaykumar Ambadas MAHESHKAR, Ball Ground, GA (US)

(72) Inventor: Jaykumar Ambadas MAHESHKAR, Ball Ground, GA (US)

(21) Appl. No.: 19/441,630

(22) Filed: Jan. 6, 2026

(51) Int. Cl. G06F 11/07

(52) U.S. Cl. CPC G06F 11/079; G06F 11/0709

(57) ABSTRACT

A system and method for agentic artificial intelligence based root cause analysis in hybrid distributed systems are disclosed. The system comprises a telemetry acquisition unit configured to collect heterogeneous telemetry from cloud based computing nodes, edge based computing nodes, and on-premise computing nodes; a data processing unit configured to normalize, temporally synchronize, and encode the telemetry into a unified representation; a multi-agent inference processor comprising a plurality of autonomous reasoning agents configured to generate diagnostic hypotheses, evaluate evidentiary support, exchange belief information, and converge on validated causal explanations; a causal knowledge representation unit configured to store and update dependency graphs, temporal propagation relationships, and confidence values based on inference outcomes; a distributed reinforcement learning processor configured to adapt diagnostic policies based on reward information representing accuracy, remediation effectiveness, computational efficiency, and environmental stability; and an actuation control unit configured to generate and execute remediation commands using counterfactual simulation and policy constrained execution.

### TECHNICAL FIELD OF THE INVENTION

The present invention relates generally to fault diagnostics and operational intelligence in complex computational infrastructures. More particularly, the invention pertains to a system and method for agentic artificial intelligence based root cause analysis in hybrid distributed systems comprising cloud-native, edge, and on-premise computational resources.

### BACKGROUND OF THE INVENTION

The transition of modern computational environments throughout the years has been from monolithic, centrally-placed systems to hybrid, multi-layered infrastructures and eventually to a full-blown use of cloud platforms, microservices, container orchestration frameworks, edge-compute nodes, and embedded control systems. The environments here have the ability to scale up or down according to their usage (dynamic), are treated as normal (stochastic), and software dependency is so intricate that no one is able to predict how a failure will propagate. Typical root cause analysis methods rely on rule-based inference, statistical profiling, or passive monitoring frameworks, which only deal with post-event data, hence their low efficiency.

Furthermore, while traditional machine-learning-based anomaly detection systems are proficient at discovering statistical outliers, they do not reveal the causal link between dispersed events, and do not make integrated reasoning over signals to find the fault origin. They cannot be considered to have any power, as they cannot come up with hypotheses, confirm them, and then carry out the required tasks. The existing monitoring tools are limited to a centralized server, dashboards, and alerting systems and thus cannot consolidate telemetry across hybrid architectures that consist of various communication fabrics, protocols, operating environments, and accommodate different QoS constraints.

With the increase in the size of systems the failure mechanisms become extremely complicated and the application of earlier techniques becomes too cumbersome and ineffective. Additionally, latency-sensitive workloads cannot have any delay either in computing or in hypothesis testing.

All these limitations in existing systems highlight the urgent need for an advanced technical agent-based system that will perform real-time, continuous, and distributed root cause analysis automatically with the ability to adapt to the environment.

The above mentioned shortcomings indicate that the current methods of finding the root cause of the problems in hybrid distributed systems are scattered, mainly reactive, sensitive to changes, unskillful in causal reasoning, and deficient in being proactive, adaptable, and comprehensible. A very promising and advanced technical solution has to come that fuses multi-agent, goal-directed AI with extensive telemetry gathering, real-time causal modeling, cross-domain reasoning, and closed-loop learning, where root cause analysis gets converted into an automatic, distributed, and ever-improving capability instead of being a dormant entity of dashboards, rules, and separate anomaly detectors.

### SUMMARY OF THE INVENTION

The invention presents a novel approach of utilizing a system and a method for root cause analysis in hybrid distributed systems with agentic AI being the basis of that. The processing units, which are numerous and autonomous, work together across cloud, edge, and on-premise setups through which the situations of suspect behavior are monitored, the cause of the anomaly is inferred, hypotheses are formed, and workflows for mitigation are implemented. The system is composed of layers for distributed sensor acquisition, high-volume telemetry transport, multi-agent inference processor, causal knowledge representation, distributed reinforcement learning optimizer, and actuation controller for automated remediation. Moreover, the invention introduces a structured device that consists of physical computational elements, memory architectures, sensor interfaces, and communication backplanes designed to facilitate agentic reasoning, causal computation, and inter-agent negotiation.

The invention effectively eradicates the need for human intervention and thus creates a new demand for adaptive, continuous, and explainable root cause analysis by merging different kinds of input streams from system logs, performance counters, message traces, hardware telemetry, network traces, and application execution semantics. The invention enhances significantly the certainity of the root cause, delays less the detection, improves the resilience of the system, and consequently, lessens human involvement.

The main goal of the inventor's idea is to make an automated, clever, and adaptable setup that can do precise and instant root cause analysis in mixed dispersed systems with cloud, edge, and on-premise resources, thus, getting rid of the drawbacks of the traditional monitoring, rule-based correlation engines, and passive machine learning tools. The invention is aimed to help the system in really early and easy detection of any odd thing, drawing the linkage, coming up with and testing the diagnosis, and even carrying out the correction with minimum human intervention or no such dependency on the static heuristics at all. Another aim is to come up with a framework built on agents spread across the network, which breaks up sophisticated diagnostics into smaller reasoning processes that can work together in an ever-changing situation where the agents independently collect evidence, negotiate solutions, update beliefs, test counterfactuals and arrive at validated causal explanations.

A further goal of the invention is to create a scalable telemetry acquisition and knowledge representation framework that integrates heterogeneous data from various sources like application logs, system metrics, network traces, configuration states, and user activity, into a temporally coherent and semantically rich format that is suitable for causal inference. Furthermore, the invention proposes a distributed, fault-tolerant architecture that can continue to perform diagnostics even during difficult situations such as network partitioning, node failures, or lack of resources, thereby guaranteeing operations of the diagnostic system even when the target infrastructure is suffering from a decrease in performance or has gone down completely.

The invention also intends to bring down the average time required for detection, diagnosis, and resolution of faults in distributed computing environments by making use of proactive, continuous, and predictive intelligence which can foresee the failure conditions and take preventive measures before the service quality is affected. Another goal is to get rid of reliance on static dependency models, manually crafted rules, and centralized processing architectures by adopting decentralized decision-making and distributed intelligence that not only grow with the system but also adjust to the constantly changing operational topologies. The invention aspires to offer a consolidated diagnostic model that can function across different administrative domains, communication protocols and data formats, thus facilitating the development of coherent cross-domain situational awareness in complex hybrid systems.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for agentic artificial intelligence based root cause analysis in hybrid distributed systems; and

FIG. 2 displays flow chart of a method for agentic artificial intelligence based root cause analysis in a hybrid distributed system.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

Embodiments of the present disclosure will be described below in detail with reference to the accompanying drawings.

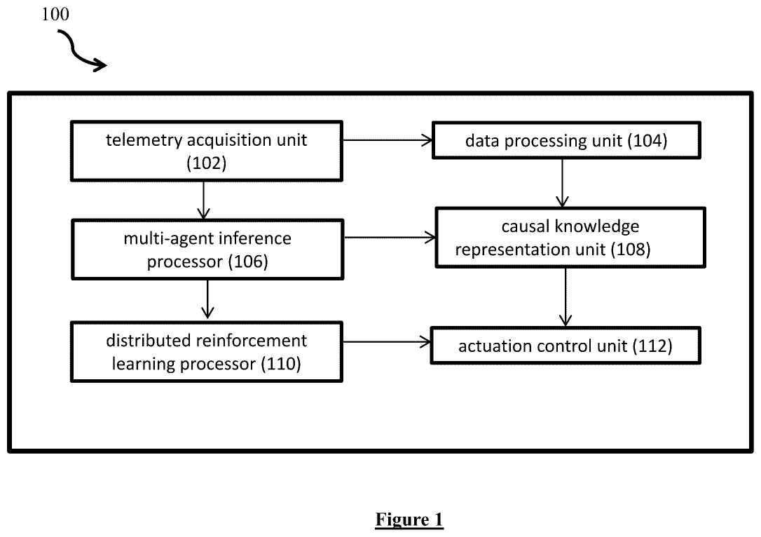

Referring to FIG. 1, a block diagram of a system for agentic artificial intelligence based root cause analysis in hybrid distributed systems is illustrated. The system 100 comprises: a telemetry acquisition unit (102) configured to receive heterogeneous telemetry data from a plurality of distributed computing nodes operating across cloud infrastructure, edge infrastructure, and on-premise infrastructure, wherein the telemetry data includes performance information, network information, application trace information, operational event information, and resource utilization information; a data processing unit (104) configured to normalize, time-align, and structurally encode the telemetry data into a unified representation suitable for causal inference; a multi-agent inference processor (106) comprising a plurality of autonomous reasoning agents, each agent defined by a state representation, a belief representation, and a policy representation, wherein each autonomous reasoning agent is configured to analyze at least a portion of the encoded telemetry data, generate diagnostic hypotheses, evaluate evidentiary support for the hypotheses, and propagate intermediate inference states to other autonomous reasoning agents; a causal knowledge representation unit (108) comprising a persistent storage structure configured to encode system dependency graphs, event propagation relationships, and temporal correlation structures, wherein the causal knowledge representation unit is continuously updated based on inference outcomes generated by the autonomous reasoning agents; a distributed reinforcement learning processor (110) configured to update the policy representation associated with each autonomous reasoning agent based on reward information derived from diagnostic accuracy, intervention effectiveness, computational cost, and environmental stability; and an actuation control unit (112) configured to generate and transmit remediation commands to at least one computing node based on validated causal hypotheses, wherein the remediation commands include at least one of service restart information, resource adjustment information, load redistribution information, configuration modification information, and operator notification information.

In an embodiment, the telemetry acquisition unit comprises a plurality of sensor interfaces configured to interface with computing nodes using heterogeneous communication protocols including message queue based communication, event stream based communication, request response based communication, and publish subscribe based communication, and wherein the telemetry acquisition unit dynamically adjusts sampling rates, filtering policies, and data prioritization rules based on detection of anomalous events or increased uncertainty in causal inference results, such that relevant telemetry information is selectively collected with increased fidelity during periods of performance instability.

In an embodiment, the data processing unit comprises a temporal synchronization processor configured to resolve timestamp discrepancies resulting from clock drift, network latency, and asynchronous sampling, and wherein the temporal synchronization processor computes probabilistic alignment scores between telemetry records originating from different computing nodes, such that temporally correlated events are represented with a consistent timeline for subsequent causal analysis.

In an embodiment, the multi-agent inference processor is configured such that the autonomous reasoning agents perform decentralized task allocation without centralized arbitration, and wherein each autonomous reasoning agent maintains a local belief representation capturing event likelihood, causal relevance, and dependency weight values, and wherein the autonomous reasoning agents exchange belief representations using a message passing procedure that incorporates belief aggregation rules, conflict resolution rules, and convergence thresholds to produce a collective causal explanation.

In an embodiment, the causal knowledge representation unit stores causal relationships as edge weighted graphs that encode directionality of event propagation, temporal precedence constraints, and probabilistic confidence values, and wherein the causal knowledge representation unit performs incremental updates using evidence weighted modification rules that incorporate new event information, agent hypotheses, environmental state transitions, and remediation outcomes, such that causal knowledge adapts to evolving system conditions.

In an embodiment, the distributed reinforcement learning processor configures each autonomous reasoning agent with a policy representation that maps environmental states, evidentiary uncertainty, and inter-agent coordination states to diagnostic actions including hypothesis refinement, additional evidence acquisition, and negotiation initiation, and wherein the distributed reinforcement learning processor computes reward values using a multi-objective optimization function that penalizes diagnostic delay, energy consumption, and false causal attribution while incentivizing rapid convergence, high accuracy, and minimal disruption to system operation.

In an embodiment, the actuation control unit performs verification of causal hypotheses using counterfactual simulation that evaluates predicted system state transitions under candidate remediation actions, and wherein the actuation control unit selects remediation actions based on predicted outcome reliability, risk constraints, dependency impact, and regulatory compliance information stored in a remediation policy repository.

In an embodiment, at least one processor of the system is configured to detect degradation of system performance in real time by applying unsupervised anomaly detection techniques to the telemetry data, trigger activation of the autonomous reasoning agents when anomalous conditions are detected, and allocate computational resources dynamically to support expedited inference under high severity conditions.

In an embodiment, the system is configured to operate under partial network connectivity and degraded computational capacity by distributing inference tasks across operational computing nodes, storing intermediate inference results in replicated storage structures, and executing degraded mode diagnostic routines that use simplified causal reasoning and limited agent coordination to maintain diagnostic continuity during infrastructure failures.

In an embodiment, the system is configured to generate explainable diagnostic reports that include causal chains, evidentiary support values, dependency graph segments, and confidence scores associated with each causal hypothesis, and wherein the explainable diagnostic reports are generated using a reasoning representation that maps internal agent state transitions, negotiation events, and reinforcement learning outcomes to human interpretable text representations without exposing underlying proprietary model parameters.

The system is implemented as a concrete hardware-implemented arrangement by expressly defining each functional element as a physically realized processing or storage unit comprising tangible electronic circuitry and executable logic instantiated on computing hardware, rather than as an abstract analytical construct. The telemetry acquisition unit is enabled as a set of physical interface circuits and communication controllers coupled to distributed computing nodes, capable of receiving, sampling, filtering, and prioritizing telemetry signals using hardware-supported protocol interfaces. The data processing unit is implemented using one or more processors and associated memory structures that perform timestamp alignment, normalization, and structural encoding through deterministic signal processing and data transformation circuits. The multi-agent inference processor is enabled as a plurality of physically instantiated processing cores or processing elements, each maintaining local state registers, belief memory regions, and policy storage, and interconnected through hardware-supported inter-processor communication pathways to exchange inference messages. The causal knowledge representation unit is realized as persistent memory hardware storing graph-structured dependency data with circuitry for incremental update and retrieval operations. The distributed reinforcement learning processor is implemented on dedicated processing circuitry executing policy update operations using stored reward values and state representations. The actuation control unit is enabled as a hardware control interface comprising secure processors, memory, and output signaling circuitry configured to issue remediation commands to external computing nodes.

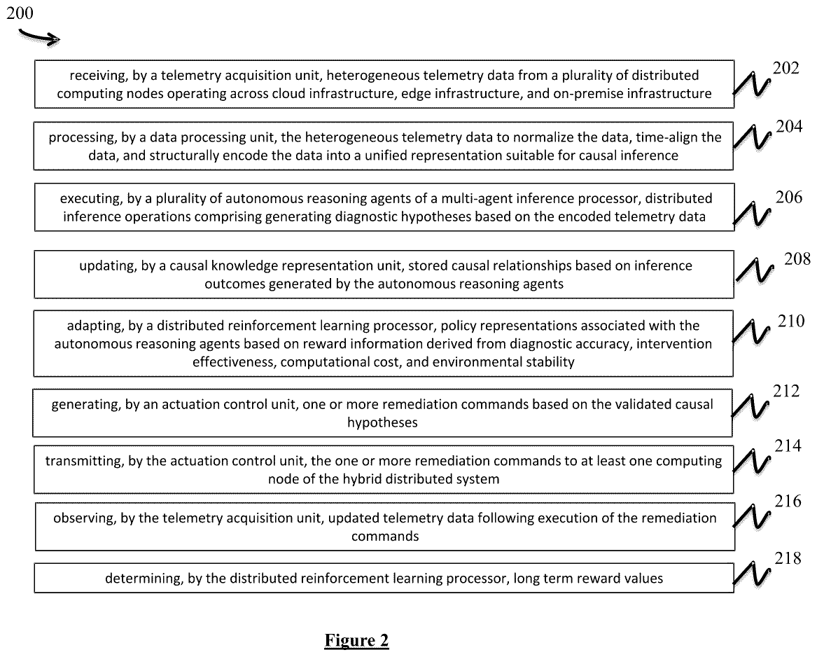

Referring to FIG. 2, a flow chart for a method for agentic artificial intelligence based root cause analysis in a hybrid distributed system, the method comprising the steps of is illustrated. The method 200 comprises:

At step 202, the method 200 includes receiving, by a telemetry acquisition unit, heterogeneous telemetry data from a plurality of distributed computing nodes operating across cloud infrastructure, edge infrastructure, and on-premise infrastructure, wherein the telemetry data comprises performance information, network information, application trace information, operational event information, and resource utilization information;

At step 204, the method 200 includes processing, by a data processing unit, the heterogeneous telemetry data to normalize the data, time-align the data, and structurally encode the data into a unified representation suitable for causal inference, wherein the processing comprises resolving timestamp discrepancies resulting from clock drift, network latency, and asynchronous sampling;

At step 206, the method 200 includes executing, by a plurality of autonomous reasoning agents of a multi-agent inference processor, distributed inference operations comprising generating diagnostic hypotheses based on the encoded telemetry data, evaluating evidentiary support associated with the diagnostic hypotheses, exchanging evidence support information with other autonomous reasoning agents using message passing procedures, and converging on validated causal hypotheses using belief aggregation rules, conflict resolution rules, and convergence thresholds;

At step 208, the method 200 includes updating, by a causal knowledge representation unit, stored causal relationships based on inference outcomes generated by the autonomous reasoning agents, wherein the updating comprises modifying dependency graph edge weights, event propagation directions, temporal precedence constraints, and probabilistic confidence information using evidence weighted modification rules;

At step 210, the method 200 includes adapting, by a distributed reinforcement learning processor, policy representations associated with the autonomous reasoning agents based on reward information derived from diagnostic accuracy, intervention effectiveness, computational cost, and environmental stability, wherein the adapting comprises computing multi-objective reward values that penalize diagnostic delay, energy consumption, and false causal attribution while incentivizing rapid convergence, high accuracy, and minimal service disruption;

At step 212, the method 200 includes generating, by an actuation control unit, one or more remediation commands based on the validated causal hypotheses, wherein the remediation commands comprise at least one of service restart information, resource adjustment information, load redistribution information, configuration modification information, and operator notification information;

At step 214, the method 200 includes transmitting, by the actuation control unit, the one or more remediation commands to at least one computing node of the hybrid distributed system;

At step 216, the method 200 includes observing, by the telemetry acquisition unit, updated telemetry data following execution of the remediation commands; and

At step 218, the method 200 includes determining, by the distributed reinforcement learning processor, long term reward values, based on recurrence frequency, remediation stability, post-remediation performance durability, and environmental variability, and modifying the policy representations associated with the autonomous reasoning agents to improve long term diagnostic accuracy and resilience of the hybrid distributed system.

In an embodiment, the step of receiving heterogeneous telemetry data further comprises dynamically adjusting sampling frequency, data filtering rules, and telemetry prioritization policies in response to detection of anomalous system states, such that the telemetry acquisition unit increases collection fidelity for metrics, logs, and traces associated with suspected fault sources, while reducing collection fidelity for metrics deemed operationally stable, thereby reducing communication bandwidth consumption and improving diagnostic responsiveness during system disturbances.

In an embodiment, the step of processing the heterogeneous telemetry data comprises executing temporal synchronization using probabilistic alignment functions that compute alignment confidence scores between telemetry records originating from different computing nodes, and wherein telemetry records with alignment confidence scores below a threshold are flagged as temporally inconsistent, stored separately, and re-evaluated during inference to reduce propagation of temporal noise through causal analysis.

In an embodiment, the step of executing distributed inference operations by autonomous reasoning agents comprises performing decentralized task allocation without centralized arbitration, wherein each autonomous reasoning agent selects diagnostic tasks based on local belief uncertainty, estimated computational cost, and inter-agent coordination state, and wherein the autonomous reasoning agents exchange partial belief representations and convergence indicators to collaboratively resolve conflicting hypotheses and minimize latency in causal determination.

In an embodiment, the step of updating stored causal relationships comprises computing incremental modifications to dependency graph structures using evidence weighted reinforcement values derived from hypothesis validation outcomes, remediation outcomes, and temporal correlations, and wherein older causal relationships with low relevance scores are pruned to maintain a compact causal representation that reflects current system behavior rather than historical but obsolete dependency patterns.

In an embodiment, the step of adapting policy representations comprises training a distributed reinforcement learning policy using a multi-agent collaborative optimization process that computes reward values based on global system performance improvement rather than individual agent performance improvement, and wherein the policy representations are periodically redistributed among agents using a consensus driven model propagation procedure to ensure uniform diagnostic capability across geographically distributed nodes.

In an embodiment, the step of generating remediation commands comprises performing counterfactual simulation that predicts system state transitions for a plurality of candidate remediation actions using stored causal relationships, and selecting remediation actions with predicted outcomes that satisfy reliability thresholds, risk constraints, regulatory requirements, and dependency integrity rules, such that remediation actions balance fault recovery effectiveness with system-wide safety.

In an embodiment, the step of transmitting remediation commands comprises executing a secure dispatch protocol that initiates remediation actions in a staged manner, monitors execution success at intermediate checkpoints, applies rollback procedures when adverse effects are detected, and triggers secondary remediation cascades when initial remediation attempts fail to restore system stability.

In an embodiment, the step of observing updated telemetry data comprises detecting discrepancies between predicted remediation outcomes and observed system responses, and computing remediation accuracy values that quantify deviation magnitude, deviation duration, and performance stabilization time, such that the system evaluates effectiveness of remediation actions under varying workload, latency, and interference conditions.

In an embodiment, the step of determining long term reward values comprises computing remediation stability metrics based on recurrence intervals, cross-service propagation frequency, and post-remediation resource consumption, and adjusting policy representations to reduce reliance on remediation actions that produce temporary stabilization but lead to long term performance degradation or increased probability of cascading failures.

In an embodiment, the step of receiving heterogeneous telemetry data comprises maintaining, by the telemetry acquisition unit, a continuously updated telemetry dependency map that associates individual telemetry attributes with upstream service invocations, downstream resource consumers, and historical fault attribution records, and wherein the telemetry acquisition unit dynamically adjusts telemetry ingestion behavior by computing, for each telemetry attribute, a diagnostic relevance score derived from recent anomaly correlation frequency, dependency depth within the telemetry dependency map, and current system disturbance indicators, and selectively modifying collection priority, sampling cadence, and transmission ordering for telemetry attributes having diagnostic relevance scores exceeding a predefined relevance threshold.

In this embodiment, the telemetry acquisition unit is implemented as a hardware-supported data intake and control subsystem that continuously observes execution behavior across cloud, edge, and on-premise nodes and incrementally constructs a telemetry dependency map reflecting real execution relationships rather than static configuration knowledge. During operation, each telemetry attribute, such as a thread wait time, input-output queue depth, network retransmission count, or application-level response latency, is bound to the execution context in which it is produced by correlating service invocation identifiers, resource handles, and historical fault attribution records derived from prior diagnostic cycles. As services invoke one another and consume shared resources, the telemetry dependency map evolves to capture both upstream causation paths, such as request fan-in from gateway services, and downstream consumption effects, such as contention on shared memory pools or network interfaces. This continuously updated map enables the telemetry acquisition unit to understand not only where telemetry originates but how it propagates influence through the system during fault scenarios.

Based on this evolving dependency map, the telemetry acquisition unit executes a real-time diagnostic relevance assessment for each telemetry attribute by evaluating its recent anomaly correlation frequency, its structural depth and connectivity within the dependency map, and contemporaneous system disturbance indicators such as rapid load fluctuations, error burst patterns, or resource exhaustion signals. For example, when a sudden increase in end-to-end transaction latency is observed, telemetry attributes associated with deeply nested downstream database calls that historically correlate with latency regressions receive higher relevance scores than superficial application counters. Similarly, during a network disturbance event, packet retransmission metrics linked to multiple upstream services may rapidly exceed the relevance threshold due to their high dependency depth and anomaly recurrence. When an attribute's diagnostic relevance score exceeds the predefined threshold, the telemetry acquisition unit automatically modifies its ingestion behavior by elevating the collection priority of that attribute, increasing its sampling cadence to capture fine-grained temporal dynamics, and reordering transmission to ensure that diagnostically critical data reaches inference components ahead of lower-impact telemetry.

The technical effect achieved by this embodiment is an adaptive, causality-aware telemetry intake mechanism that concentrates monitoring resources on the most diagnostically informative signals during abnormal system states, while conserving bandwidth and processing capacity during stable operation. By dynamically reshaping telemetry ingestion in response to evolving dependency relationships and disturbance conditions, the system ensures that downstream causal inference operates on high-resolution, high-relevance data precisely when faults emerge, thereby enabling faster root cause isolation, reducing diagnostic ambiguity, and improving overall system resilience in complex hybrid distributed environments.

In an embodiment, the step of processing the heterogeneous telemetry data further comprises partitioning, by the data processing unit, normalized telemetry records into overlapping temporal inference segments defined by adaptive time windows whose boundaries are computed based on detected state transition density rather than fixed durations, and wherein each temporal inference segment is annotated with causality context metadata identifying precursor events, concurrent resource contention indicators, and post-event propagation paths prior to being provided to the plurality of autonomous reasoning agents, and wherein the step of processing the heterogeneous telemetry data further comprises executing, by the data processing unit, causal consistency validation operations that evaluate whether temporal ordering constraints across telemetry records violate known dependency execution sequences stored by the causal knowledge representation unit, and conditionally reordering, suppressing, or duplicating telemetry records within a temporal inference segment to preserve causally valid execution traces prior to inference.

In this embodiment, the data processing unit functions as a causality-preserving temporal structuring component that transforms normalized telemetry streams into inference-ready representations aligned with actual system behavior rather than arbitrary clock intervals. After normalization and time alignment, the telemetry records are continuously analyzed to detect changes in system state, such as abrupt transitions from steady throughput to saturation, rapid escalation of error codes, or sudden shifts in resource utilization gradients. Instead of segmenting telemetry using fixed-duration windows, the data processing unit computes adaptive window boundaries by measuring state transition density, where a high concentration of correlated state changes within a short span triggers the formation of finer-grained temporal inference segments. For example, during a cascading failure initiated by a configuration change, multiple rapid transitions—such as cache invalidations, connection retries, and thread pool exhaustion—may occur within seconds, prompting the creation of overlapping segments that tightly capture the evolving fault dynamics, while low-activity periods are represented using broader segments.

Each temporal inference segment is then enriched with causality context metadata that explicitly encodes precursor events, such as deployment triggers or threshold crossings that precede observable degradation, concurrent resource contention indicators, such as shared storage queue buildup or network interface saturation, and post-event propagation paths that trace how effects spread across dependent services and infrastructure layers. This contextual annotation allows autonomous reasoning agents to reason over not only what occurred within a segment but also why it occurred and how its effects propagated, enabling multi-agent inference to distinguish primary causal factors from secondary symptoms. For instance, an inference segment may indicate that a spike in application latency is preceded by a schema migration event, coincides with elevated disk wait times, and propagates downstream as increased timeout rates in consumer services.

Prior to delivering the annotated segments to the autonomous reasoning agents, the data processing unit performs causal consistency validation by comparing the observed temporal ordering of telemetry records against known execution dependencies maintained by the causal knowledge representation unit. This validation identifies inconsistencies arising from clock drift, asynchronous sampling, or delayed event reporting, such as when a downstream failure appears to occur before an upstream triggering event in raw telemetry. When such violations are detected, the data processing unit conditionally reorders telemetry records to restore correct cause-precedence relationships, suppresses redundant or misleading records that cannot be reliably ordered, or duplicates key events across overlapping segments to ensure continuity of causal traces. The technical effect achieved by this embodiment is the generation of temporally coherent, causally valid inference inputs that preserve true execution semantics across heterogeneous systems, thereby enabling autonomous reasoning agents to perform accurate root cause analysis even in environments characterized by distributed clocks, variable latency, and asynchronous telemetry generation.

In an embodiment, the step of executing distributed inference operations by the plurality of autonomous reasoning agents comprises, for each autonomous reasoning agent, generating an internal belief state representation that encodes hypothesis confidence values, evidentiary provenance identifiers, and temporal support ranges, and iteratively updating said belief state representation in response to incoming inter-agent messages that include partial belief deltas, contradiction indicators, and convergence likelihood estimates received through asynchronous message exchange channels, and wherein the step of executing distributed inference operations further comprises computing, by each autonomous reasoning agent, hypothesis prioritization scores based on a combination of belief uncertainty magnitude, causal graph traversal depth, and estimated remediation impact radius, and allocating local computational resources preferentially to hypotheses exhibiting both high uncertainty and high potential impact on downstream services, while deprioritizing hypotheses associated with localized or previously resolved fault patterns.

In this embodiment, each autonomous reasoning agent is realized as an independently executing inference process that maintains a continuously evolving internal belief state representation serving as its local diagnostic knowledge base. Upon receiving temporally structured telemetry segments, the agent instantiates multiple candidate causal hypotheses, each hypothesis being associated with a confidence value that quantifies the agent's current degree of belief, one or more evidentiary provenance identifiers that reference the specific telemetry attributes, segments, and dependency paths supporting the hypothesis, and a temporal support range that bounds the time interval over which the evidence remains causally valid. This structured belief state allows the agent to distinguish between hypotheses that are strongly supported by recent, high-fidelity evidence and those that rely on older or indirectly inferred signals, thereby enabling time-aware diagnostic reasoning in dynamic system conditions.

As distributed inference progresses, belief state updates are driven by asynchronous inter-agent message exchanges rather than centralized coordination. Each agent transmits partial belief deltas that reflect incremental changes in confidence for specific hypotheses, contradiction indicators that signal incompatibilities between competing causal explanations, and convergence likelihood estimates that quantify the probability that a hypothesis will remain stable under additional evidence. For example, a storage-focused agent may inform a compute-focused agent that confidence in an input-output saturation hypothesis has increased due to correlated queue depth growth, while simultaneously flagging a contradiction with a previously assumed CPU bottleneck explanation. Upon receiving such messages, the agent updates its belief state by adjusting confidence values, narrowing or expanding temporal support ranges, and revising provenance links to reflect newly incorporated evidence. This iterative exchange continues until belief changes fall below convergence thresholds, indicating stabilization of causal understanding across agents.

In parallel, each autonomous reasoning agent computes hypothesis prioritization scores to manage its finite computational resources efficiently. These scores are derived by combining the magnitude of belief uncertainty, which identifies hypotheses requiring additional evidence, the traversal depth of the hypothesis within the causal graph, which reflects how far upstream the potential cause lies, and an estimated remediation impact radius that predicts how many downstream services or resources would be affected if the hypothesis is correct. For instance, a high-uncertainty hypothesis involving a deeply nested upstream dependency with the potential to disrupt multiple downstream services receives a higher prioritization score than a well-understood, low-impact fault localized to a single component. Based on these scores, the agent allocates processing cycles, memory, and inference bandwidth preferentially to high-priority hypotheses, while deprioritizing hypotheses that correspond to previously resolved fault patterns or that are confined to isolated components. The technical effect achieved by this embodiment is a scalable, impact-aware distributed inference mechanism that accelerates convergence on systemically significant root causes, reduces unnecessary computation on low-value hypotheses, and enhances overall diagnostic accuracy in large-scale hybrid distributed systems.

In an embodiment, the step of executing distributed inference operations further comprises detecting, by the multi-agent inference processor, inter-agent hypothesis conflicts by comparing belief state representations received from different autonomous reasoning agents, classifying detected conflicts based on temporal disagreement, dependency disagreement, or evidentiary sufficiency disagreement, and applying conflict resolution rules that selectively request additional telemetry acquisition, defer hypothesis acceptance, or initiate targeted belief reconciliation exchanges among a subset of the autonomous reasoning agents associated with the conflicting hypotheses, and wherein the step of updating stored causal relationships comprises performing, by the causal knowledge representation unit, fine-grained edge adjustment operations on a causal dependency graph by incrementally modifying causal strength values, temporal lag parameters, and propagation likelihoods based on quantified alignment between predicted causal outcomes and observed telemetry responses following remediation execution, and wherein causal edges exhibiting persistent misalignment across multiple inference cycles are demoted or temporarily disabled from active inference participation; and wherein the step of updating stored causal relationships further comprises maintaining versioned causal graph snapshots that record historical states of causal dependencies along with associated confidence decay functions, and selectively reverting portions of the causal dependency graph to prior versions when detected remediation outcomes contradict recent causal updates beyond an acceptable deviation threshold.

In this embodiment, the multi-agent inference processor operates as a supervisory coordination layer that continuously evaluates the consistency of diagnostic conclusions emerging from independently operating autonomous reasoning agents. As belief state representations are exchanged, the multi-agent inference processor compares the confidence values, temporal support ranges, and evidentiary provenance associated with competing hypotheses to identify inter-agent conflicts. These conflicts are classified according to their underlying nature, such as temporal disagreement where agents assert incompatible ordering of causal events, dependency disagreement where agents attribute the same symptom to different upstream components, or evidentiary sufficiency disagreement where one agent deems available telemetry adequate while another identifies gaps or weak correlations. For example, one agent may assert that a database slowdown precedes application latency based on transaction traces, while another agent infers the reverse due to misaligned timestamps, triggering a temporal disagreement classification.

Upon detecting such conflicts, the multi-agent inference processor applies predefined conflict resolution rules that are selectively tailored to the conflict type. In cases of evidentiary insufficiency, the processor may request targeted telemetry acquisition focused on specific attributes or dependency paths to strengthen causal signals. For temporal disagreements, hypothesis acceptance may be deferred until additional temporal consistency validation is performed or until overlapping inference segments converge. In scenarios involving dependency disagreement, the processor initiates targeted belief reconciliation exchanges among only those agents directly associated with the conflicting hypotheses, reducing unnecessary communication overhead. Through these controlled interactions, agents iteratively align their belief states without requiring global synchronization, enabling distributed yet coherent diagnostic reasoning. The technical effect of this mechanism is the suppression of premature or inconsistent root cause conclusions and the promotion of consensus-based inference grounded in sufficient and causally consistent evidence.

Following remediation execution, the causal knowledge representation unit updates the underlying causal dependency graph using fine-grained edge adjustment operations that reflect empirical system behavior rather than static assumptions. Each causal edge is incrementally modified by adjusting its strength value, temporal lag parameter, and propagation likelihood based on how closely predicted outcomes match observed telemetry responses after remediation. For instance, if throttling a suspected upstream service leads to an immediate and proportionate reduction in downstream error rates, the corresponding causal edge is strengthened and its temporal lag refined. Conversely, if repeated remediation actions fail to produce expected effects, the affected causal edges are demoted or temporarily disabled from active inference participation, preventing unreliable relationships from biasing future diagnoses. This adaptive refinement ensures that the causal graph remains aligned with evolving system dynamics.

Additionally, the causal knowledge representation unit maintains versioned snapshots of the causal dependency graph, each snapshot capturing the state of causal relationships at a given inference cycle along with associated confidence decay functions that model the diminishing reliability of older knowledge. When observed remediation outcomes contradict recent causal updates beyond an acceptable deviation threshold, selective reversion is performed in which only the affected portions of the graph are rolled back to a prior, more reliable version. For example, if a newly inferred dependency proves unstable under varied workload conditions, the system can revert that edge while preserving other validated updates. The technical effect achieved by this embodiment is a resilient, self-correcting causal knowledge base that balances adaptability with stability, enabling accurate long-term root cause analysis even as system architectures, workloads, and failure modes evolve over time.

In an embodiment, the step of adapting policy representations associated with the autonomous reasoning agents comprises computing, by the distributed reinforcement learning processor, composite reward vectors that integrate short-term diagnostic accuracy signals with long-horizon stability indicators derived from post-remediation telemetry trends, and updating agent policy parameters using said composite reward vectors in a manner that explicitly balances exploration of alternative causal explanations against exploitation of previously validated diagnostic strategies, and wherein the step of adapting policy representations further comprises coordinating, by the distributed reinforcement learning processor, inter-agent policy alignment operations in which policy update summaries, gradient contribution indicators, and uncertainty estimates are exchanged among autonomous reasoning agents, and wherein policy synchronization is selectively applied only to policy components associated with shared dependency domains to avoid homogenization of localized diagnostic expertise.

In this embodiment, the distributed reinforcement learning processor functions as a closed-loop adaptation mechanism that continuously refines the decision-making behavior of the autonomous reasoning agents based on observed diagnostic and remediation outcomes. Following each inference and remediation cycle, the processor computes composite reward vectors that combine immediate diagnostic accuracy signals, such as whether the selected root cause hypothesis correctly explains observed symptom resolution, with long-horizon stability indicators derived from post-remediation telemetry trends. These long-horizon indicators capture effects such as fault recurrence frequency, sustained performance improvement, and absence of secondary degradations over extended observation windows. For example, if a remediation action resolves a latency spike but is followed by intermittent instability in related services, the short-term accuracy reward may be positive while the long-term stability component is discounted, producing a balanced composite reward that discourages brittle diagnostic strategies.

Using these composite reward vectors, each autonomous reasoning agent updates its policy parameters in a manner that explicitly manages the trade-off between exploration and exploitation. Exploration is encouraged when uncertainty remains high or when historical remediation strategies exhibit diminishing returns, prompting agents to consider alternative causal explanations or less frequently selected remediation paths. Exploitation is favored when a diagnostic strategy has repeatedly demonstrated stable recovery across varying workload conditions. For instance, an agent may learn to initially explore multiple upstream dependency hypotheses during novel failure patterns, but progressively exploit a validated strategy once consistent causal alignment and stable recovery are observed. This adaptive policy update process ensures that agents do not overfit to transient patterns while still capitalizing on proven diagnostic knowledge.

In addition, the distributed reinforcement learning processor coordinates inter-agent policy alignment operations that enable knowledge sharing without eroding specialization. During these operations, autonomous reasoning agents exchange concise policy update summaries, gradient contribution indicators that describe the relative influence of recent learning signals, and uncertainty estimates that reflect confidence in updated policy components. Rather than enforcing global synchronization, the processor selectively applies policy alignment only to policy components associated with shared dependency domains, such as common infrastructure layers or jointly utilized services. For example, agents responsible for network and compute diagnostics may align policies related to congestion handling, while retaining distinct policies for domain-specific fault patterns. The technical effect achieved by this embodiment is a distributed learning system that converges toward robust, system-wide diagnostic strategies while preserving localized expertise, resulting in improved adaptability, reduced diagnostic oscillation, and sustained system stability across heterogeneous operating conditions.

In an embodiment, the step of generating one or more remediation commands comprises decomposing, by the actuation control unit, each validated causal hypothesis into a sequence of ordered remediation primitives corresponding to service control actions, resource reallocation actions, and configuration modification actions, and assembling said remediation primitives into execution plans that respect inter-service dependency constraints, rollback feasibility conditions, and temporal coordination requirements derived from the causal knowledge representation unit, and wherein the step of generating one or more remediation commands further comprises evaluating, for each execution plan, predicted interference effects with concurrently executing remediation plans and scheduled operational activities, and conditionally serializing, parallelizing, or deferring remediation primitives based on predicted contention, execution overlap, and cumulative risk assessment values.

In this embodiment, the actuation control unit operates as a deterministic execution planning and control subsystem that transforms validated causal hypotheses into concrete, safe, and context-aware remediation actions. Once a causal hypothesis is confirmed by the multi-agent inference process, the actuation control unit decomposes the hypothesis into a structured sequence of remediation primitives, each primitive representing an atomic, executable control action that can be reliably applied to the system. These primitives may include service control actions such as restarting or throttling a specific service instance, resource reallocation actions such as dynamically adjusting processor core assignments or memory quotas, and configuration modification actions such as altering timeout thresholds or connection pool limits. By decomposing remediation into discrete primitives, the system ensures that complex corrective actions are expressed in a form that can be ordered, monitored, and reversed if necessary.

The actuation control unit then assembles the remediation primitives into execution plans that explicitly account for inter-service dependency constraints and operational safety requirements derived from the causal knowledge representation unit. For example, if a downstream service depends on the availability of an upstream authentication service, the execution plan enforces an ordering in which authentication service configuration changes or restarts are completed and verified before downstream remediation primitives are executed. Rollback feasibility conditions are also evaluated at this stage, ensuring that each primitive either has a defined compensating action or is placed in a sequence position where partial execution can be safely undone. Temporal coordination requirements are incorporated to prevent destabilizing the system, such as spacing resource reallocation actions to avoid synchronized load spikes across multiple nodes.

Prior to issuing remediation commands, the actuation control unit evaluates predicted interference effects between the planned execution and other ongoing remediation activities or scheduled operational tasks, such as deployments or maintenance windows. This evaluation uses dependency overlap analysis and risk assessment values to estimate potential contention for shared resources or conflicting configuration changes. For instance, if two remediation plans both target the same storage subsystem, the unit may serialize their execution to avoid compounded load, whereas independent remediation primitives affecting separate subsystems may be safely parallelized. In cases where cumulative risk exceeds acceptable thresholds, remediation primitives may be deferred until system conditions stabilize. The technical effect achieved by this embodiment is a controlled, dependency-aware remediation mechanism that minimizes secondary failures, reduces operational risk, and ensures that corrective actions are executed in a manner that is both effective and reversible within complex, continuously operating distributed environments.

In an embodiment, the step of transmitting the one or more remediation commands comprises issuing, by the actuation control unit, execution acknowledgements and progress signals for individual remediation primitives, continuously correlating received execution feedback with expected causal effect timelines stored in the causal knowledge representation unit, and interrupting or modifying in-progress remediation execution when observed system responses diverge from predicted causal trajectories beyond a predefined tolerance range, and wherein the step of observing updated telemetry data further comprises computing, by the telemetry acquisition unit, post-remediation causal validation datasets that isolate telemetry changes attributable to remediation actions from telemetry changes caused by concurrent workload variation, background noise, or unrelated system events, and providing said causal validation datasets as structured inputs to subsequent inference and policy adaptation cycles, and wherein the step of determining long term reward values comprises aggregating, by the distributed reinforcement learning processor, multi-cycle remediation outcome histories that encode fault recurrence intervals, cross-component fault propagation patterns, and remediation-induced performance side effects, and adjusting future policy representations to progressively reduce selection probability of remediation strategies associated with unstable or transient recovery behavior across heterogeneous operating conditions.

In this embodiment, the actuation control unit is configured to operate as a closed-loop execution supervisor that maintains continuous visibility into the real-time progress and effects of each issued remediation command. As remediation primitives are dispatched to their respective execution targets, the actuation control unit generates and receives explicit execution acknowledgements and fine-grained progress signals that indicate initiation, intermediate state transitions, and completion status of each primitive. These signals are continuously correlated with expected causal effect timelines stored in the causal knowledge representation unit, which encode anticipated temporal response patterns such as the expected delay between a configuration change and observable stabilization of downstream latency. When observed system responses deviate from predicted causal trajectories beyond a predefined tolerance range, for example when a service restart fails to reduce error rates within the expected time window or produces secondary performance degradation, the actuation control unit dynamically interrupts or modifies the in-progress remediation execution by pausing subsequent primitives, triggering compensating rollback actions, or adjusting execution parameters in real time. The technical effect of this supervisory mechanism is the prevention of runaway remediation actions and the containment of unintended side effects during fault recovery.

Following remediation execution, the telemetry acquisition unit enters a post-remediation observation phase in which updated telemetry streams are analyzed to construct causal validation datasets that specifically attribute observed system changes to the executed remediation actions. This attribution is achieved by isolating telemetry variations that temporally and structurally align with the remediation timeline and dependency paths, while discounting variations arising from concurrent workload fluctuations, background noise, or unrelated operational events. For example, throughput improvements that coincide with a scaling action and propagate along known dependency edges are included in the validation dataset, whereas performance changes caused by external traffic surges are excluded. These post-remediation causal validation datasets are structured and forwarded as inputs to subsequent inference and policy adaptation cycles, enabling the system to learn from the true effects of its actions rather than from coincidental correlations. The technical effect achieved is a high-fidelity feedback signal that strengthens causal learning and reduces reinforcement of spurious relationships.

In parallel, the distributed reinforcement learning processor aggregates long-term remediation outcome histories across multiple inference cycles to compute durable reward values that reflect sustained system behavior. These histories encode fault recurrence intervals, patterns of cross-component fault propagation, and remediation-induced performance side effects such as increased resource consumption or degraded latency in adjacent services. By analyzing these multi-cycle outcomes, the processor adjusts future policy representations to progressively reduce the selection probability of remediation strategies that yield only transient recovery or introduce instability under varying operating conditions. For instance, a remediation action that repeatedly resolves faults temporarily but leads to recurrent degradation is down-weighted in future policy decisions. The technical effect of this embodiment is the evolution of remediation policies toward stable, system-wide recovery strategies that remain effective across heterogeneous workloads and deployment environments, thereby improving long-term resilience and operational efficiency.

The system and method for agentic artificial intelligence based root cause analysis in hybrid distributed systems operates through a continuous closed-loop cycle of telemetry acquisition, data processing, distributed inference, causal knowledge updating, policy optimization, remediation execution, and post-remediation evaluation. The system begins by acquiring heterogeneous telemetry data from computing nodes spanning cloud infrastructure, edge infrastructure, and on-premise environments. Telemetry streams include multi-dimensional operational information such as application performance metrics, network packet statistics, storage latency measurements, application trace identifiers, system log records, and resource utilization values. The telemetry acquisition unit is configured to dynamically adjust sampling frequency and prioritization based on detection of anomalous conditions or insufficient certainty in ongoing inference activities. When anomalies are suspected, the system increases collection fidelity for selected telemetry streams, selectively enriching evidence available for causal analysis while maintaining overall communication efficiency and processing throughput.

Once telemetry is received, the data processing unit performs normalization, temporal alignment, and structural encoding. Temporal synchronization is a critical step because telemetry originates from autonomous nodes operating with potentially unsynchronized clocks, fluctuating network latency, and divergent sampling cycles. The system applies probabilistic alignment functions to compute confidence measures associated with temporal relationships between records originating from different components. Telemetry records with low alignment confidence are flagged and processed with reduced influence to minimize distortion of subsequent inference and causal representation. The processed telemetry is encoded in a unified format that preserves temporal ordering, logical dependencies, semantic attributes, and quantitative measurements, enabling seamless integration into distributed reasoning pipelines.

Distributed inference is achieved by message passing between autonomous reasoning agents. Rather than operating in isolation, each agent exchanges partial beliefs, hypothesis scores, and conflict indicators with peer agents. The network of agents collaboratively aggregates belief states using defined aggregation and conflict resolution rules. When conflicting hypotheses arise, convergence thresholds are used to determine whether further evidence acquisition is required, whether a hypothesis should be revised, or whether agents must reallocate diagnostic tasks. This decentralized architecture enables parallel exploration of multiple causal paths, dramatically reducing diagnostic latency compared to monolithic inference systems.

The causal knowledge representation unit serves as the persistent memory that informs and evolves the system's understanding of operational dynamics. Causal relationships are encoded as directed, weighted graphs in which nodes represent system components or measurable events, and edges represent propagation relationships with associated temporal precedence constraints and confidence scores. When distributed inference produces validated hypotheses, the causal knowledge representation unit performs incremental updates using evidence-weighted modification rules. Edge weights are increased when repeated inference outcomes reinforce a causal dependency, while obsolete or low-confidence relationships are decay-adjusted or pruned. This process ensures that the causal model adapts to evolving system behaviors while maintaining computational tractability.

To support continual adaptation, the system incorporates a distributed reinforcement learning processor that updates the diagnostic policies of autonomous reasoning agents. Each agent maintains a policy mapping that determines appropriate diagnostic actions based on current belief states, environmental uncertainty, and computational constraints. Policy optimization occurs by computing reward values based on diagnostic accuracy, remediation effectiveness, cost-efficiency, and environmental stability. The reward functions penalize undesirable characteristics such as diagnostic delay, excessive computational consumption, and inaccurate fault attribution. Conversely, the functions incentivize rapid convergence on correct hypotheses, continuous reduction in false positives, and execution of interventions with minimal disruption to operational workloads. Policy updates may be propagated across agents using consensus-driven mechanisms to ensure uniform diagnostic capability throughout the distributed network.

Following inference, validated causal hypotheses are transferred to the actuation control unit, which determines appropriate remediation actions. Remediation determination involves counterfactual simulation in which predicted system state transitions are computed for a set of candidate interventions. The system evaluates the likely outcomes under varying assumptions of fault severity, propagation velocity, and dependency impact. Candidate remediation actions that satisfy reliability thresholds, risk constraints, and regulatory constraints are selected. Remediation commands may include service restart instructions, resource scaling decisions, traffic re-routing directives, configuration adjustments, or targeted notifications to operators. Execution is performed using a staged dispatch mechanism with checkpoint verification, rollback capabilities, and safety validation to prevent unintended service degradation.

After remediation commands are executed, the telemetry acquisition unit resumes observation of system state to detect deviations between predicted intervention outcomes and actual system behavior. The system computes remediation accuracy metrics based on deviation magnitude, stabilization time, and recurrence frequency. Post-remediation telemetry is fed back into both the causal knowledge representation unit and the distributed reinforcement learning processor. The causal model is updated when remediation outcomes yield new insights into system dependencies or previously unknown propagation dynamics. The reinforcement learning processor computes long-term reward values that evaluate remediation durability, environmental variability, and resource usage. Policies are adjusted to reduce reliance on remediation actions with short-lived effects that require repeated application.

The technique is designed to maintain diagnostic continuity under degraded operational conditions. When network partitions, sensor failures, or computational deficits occur, the system enters a degraded reasoning mode characterized by reduced complexity inference and minimal evidence sets. Agents continue to exchange reduced belief representations and maintain approximate causal structures. Although diagnostic precision may be temporarily reduced, the system continues to produce probabilistic explanations and, when necessary, conservative remediation suggestions until full telemetry visibility is restored.

A key differentiating feature of the technique is its capability for active evidence seeking. When inference uncertainty remains high or conflicting hypotheses are unresolved, agents trigger targeted evidence acquisition requests. These requests instruct telemetry acquisition components to collect additional data from specific computing nodes, thus converting the inference process from reactive interpretation to proactive hypothesis validation. This ability to request evidence dynamically significantly reduces false attribution and accelerates convergence.

The technique also incorporates multi-policy management, wherein multiple diagnostic policies with different exploration and exploitation characteristics are retained. When system instability or high-severity anomalies occur, exploratory policies designed to aggressively gather evidence may be activated. When stability is restored, exploitation-focused policies that prioritize efficiency and low disruption may take precedence. Dynamic policy switching preserves diagnostic agility while ensuring operational stability.

The invention includes a device configured as an autonomous root cause analysis apparatus comprising a multi-core computational processor, a distributed co-processing accelerator, a high-speed memory subsystem, a plurality of sensory I/O interfaces, a network interface transceiver, and a dynamically adaptive firmware designed to coordinate agentic reasoning operations. The device includes a hierarchical communication backplane configured for low-latency interconnect between the processing units and hardware monitoring circuits. The device further comprises a persistent memory storage subsystem hosting causal knowledge graphs, diagnostic models, and agent-level behavioral policies. The device is capable of executing root cause analysis tasks autonomously, hosting distributed agent processes, encoding inference models, training reinforcement learning policies in real-time, and actuating remediation commands over hybrid infrastructures.

The system comprises a distributed telemetry acquisition unit configured to collect, normalize, and encode data from a plurality of heterogeneous sources such as cloud orchestration logs, network metrics, application traces, QoS statistics, hardware counters, and environmental sensors. The telemetry data is streamed over a scalable communication fabric employing message queues, event buses, and lightweight publish-subscribe protocols. The communication fabric functions as a high-throughput transport layer optimized for congestion minimization, multi-path routing, and adaptive bandwidth allocation.

A multi-agent inference processor executes a plurality of autonomous reasoning agents, each programmed with goal-oriented task decomposition capability. The agents collectively analyze telemetry data using a causal inference model to determine latent relationships between distributed events. The agents self-organize, assign responsibilities, negotiate hypotheses, and converge upon a logically consistent explanation for observed anomalies. Each agent includes a localized policy vector optimized through a distributed reinforcement learning technique, enabling adaptive behavior based on environmental observation and historical reward outcomes.

The causal knowledge representation unit encodes temporal correlations, dependency graphs, and failure propagation models into structured knowledge graphs. The causal representation is continuously updated based on observed events and inference outcomes, enabling real-time learning. The causal model supports counterfactual reasoning, enabling the system to evaluate hypothetical fault scenarios, and predictive reasoning, enabling proactive mitigation of faults before they manifest into system-wide failures.

A distributed reinforcement learning optimizer employs multi-agent cooperative policy optimization methods to adapt behavioral strategies of inference agents. The optimizer operates across cloud-edge boundaries, allowing policy convergence despite varying computational cost constraints, latency, and energy budgets. The optimizer continuously evaluates agent performance metrics including accuracy of hypothesis prediction, false-positive rate, and remediation success rate. Reward functions incentivize rapid, accurate, and low-disruption operational strategies.

An actuation controller receives validated root cause hypotheses and autonomously executes mitigation workflows such as service restart, traffic rerouting, configuration reallocation, resource scaling, firmware patching, or operator notification. The actuation controller ensures safe execution using constraint models to prevent cascading failures or untested interventions. The controller further maintains an audit of all actions, enabling traceability of agent behavior.

The method begins by acquiring telemetry streams from distributed nodes, followed by normalization, encoding, and time-synchronization of multi-modal signals. The system performs anomaly detection using unsupervised and semi-supervised statistical models, triggering agent activation upon detection of deviation. The agents independently generate hypotheses based on causal models, evaluate evidence, and propagate intermediate reasoning states to cooperating agents. The agents iteratively refine hypotheses through negotiation and distributed inference, converging on a causal explanation. Upon validation, the system determines an optimal mitigation action, executes remediation, observes environmental response, and updates policy functions through reinforcement learning.

1. A method for agentic artificial intelligence based root cause analysis in a hybrid distributed system, the method comprising the steps of:
receiving, by a telemetry acquisition unit, heterogeneous telemetry data from a plurality of distributed computing nodes operating across cloud infrastructure, edge infrastructure, and on-premise infrastructure, wherein the telemetry data comprises performance information, network information, application trace information, operational event information, and resource utilization information;
processing, by a data processing unit, the heterogeneous telemetry data to normalize the data, time-align the data, and structurally encode the data into a unified representation suitable for causal inference, wherein the processing comprises resolving timestamp discrepancies resulting from clock drift, network latency, and asynchronous sampling;
executing, by a plurality of autonomous reasoning agents of a multi-agent inference processor, distributed inference operations comprising generating diagnostic hypotheses based on the encoded telemetry data, evaluating evidentiary support associated with the diagnostic hypotheses, exchanging evidence support information with other autonomous reasoning agents using message passing procedures, and converging on validated causal hypotheses using belief aggregation rules, conflict resolution rules, and convergence thresholds;
updating, by a causal knowledge representation unit, stored causal relationships based on inference outcomes generated by the autonomous reasoning agents, wherein the updating comprises modifying dependency graph edge weights, event propagation directions, temporal precedence constraints, and probabilistic confidence information using evidence weighted modification rules;
adapting, by a distributed reinforcement learning processor, policy representations associated with the autonomous reasoning agents based on reward information derived from diagnostic accuracy, intervention effectiveness, computational cost, and environmental stability, wherein the adapting comprises computing multi-objective reward values that penalize diagnostic delay, energy consumption, and false causal attribution while incentivizing rapid convergence, high accuracy, and minimal service disruption;
generating, by an actuation control unit, one or more remediation commands based on the validated causal hypotheses, wherein the remediation commands comprise at least one of service restart information, resource adjustment information, load redistribution information, configuration modification information, and operator notification information;
transmitting, by the actuation control unit, the one or more remediation commands to at least one computing node of the hybrid distributed system;
observing, by the telemetry acquisition unit, updated telemetry data following execution of the remediation commands; and
determining, by the distributed reinforcement learning processor, long term reward values, based on recurrence frequency, remediation stability, post-remediation performance durability, and environmental variability, and modifying the policy representations associated with the autonomous reasoning agents to improve long term diagnostic accuracy and resilience of the hybrid distributed system, wherein the step of receiving heterogeneous telemetry data comprises maintaining, by the telemetry acquisition unit, a continuously updated telemetry dependency map that associates individual telemetry attributes with upstream service invocations, downstream resource consumers, and historical fault attribution records, and wherein the telemetry acquisition unit dynamically adjusts telemetry ingestion behavior by computing, for each telemetry attribute, a diagnostic relevance score derived from recent anomaly correlation frequency, dependency depth within the telemetry dependency map, and current system disturbance indicators, and selectively modifying collection priority, sampling cadence, and transmission ordering for telemetry attributes having diagnostic relevance scores exceeding a predefined relevance threshold; and
wherein the step of processing the heterogeneous telemetry data further comprises partitioning, by the data processing unit, normalized telemetry records into overlapping temporal inference segments defined by adaptive time windows whose boundaries are computed based on detected state transition density rather than fixed durations, and wherein each temporal inference segment is annotated with causality context metadata identifying precursor events, concurrent resource contention indicators, and post-event propagation paths prior to being provided to the plurality of autonomous reasoning agents, and wherein the step of processing the heterogeneous telemetry data further comprises executing, by the data processing unit, causal consistency validation operations that evaluate whether temporal ordering constraints across telemetry records violate known dependency execution sequences stored by the causal knowledge representation unit, and conditionally reordering, suppressing, or duplicating telemetry records within a temporal inference segment to preserve causally valid execution traces prior to inference.

2. The method of claim 1, wherein the step of receiving heterogeneous telemetry data further comprises dynamically adjusting sampling frequency, data filtering rules, and telemetry prioritization policies in response to detection of anomalous system states, such that the telemetry acquisition unit increases collection fidelity for metrics, logs, and traces associated with suspected fault sources, while reducing collection fidelity for metrics deemed operationally stable, thereby reducing communication bandwidth consumption and improving diagnostic responsiveness during system disturbances.

3. The method of claim 1, wherein the step of processing the heterogeneous telemetry data comprises executing temporal synchronization using probabilistic alignment functions that compute alignment confidence scores between telemetry records originating from different computing nodes, and wherein telemetry records with alignment confidence scores below a threshold are flagged as temporally inconsistent, stored separately, and re-evaluated during inference to reduce propagation of temporal noise through causal analysis.

4. The method of claim 1, wherein the step of executing distributed inference operations by autonomous reasoning agents comprises performing decentralized task allocation without centralized arbitration, wherein each autonomous reasoning agent selects diagnostic tasks based on local belief uncertainty, estimated computational cost, and inter-agent coordination state, and wherein the autonomous reasoning agents exchange partial belief representations and convergence indicators to collaboratively resolve conflicting hypotheses and minimize latency in causal determination.

5. The method of claim 1, wherein the step of updating stored causal relationships comprises computing incremental modifications to dependency graph structures using evidence weighted reinforcement values derived from hypothesis validation outcomes, remediation outcomes, and temporal correlations, and wherein older causal relationships with low relevance scores are pruned to maintain a compact causal representation that reflects current system behavior rather than historical but obsolete dependency patterns.

6. The method of claim 1, wherein the step of adapting policy representations comprises training a distributed reinforcement learning policy using a multi-agent collaborative optimization process that computes reward values based on global system performance improvement rather than individual agent performance improvement, and wherein the policy representations are periodically redistributed among agents using a consensus driven model propagation procedure to ensure uniform diagnostic capability across geographically distributed nodes.

7. The method of claim 1, wherein the step of generating remediation commands comprises performing counterfactual simulation that predicts system state transitions for a plurality of candidate remediation actions using stored causal relationships, and selecting remediation actions with predicted outcomes that satisfy reliability thresholds, risk constraints, regulatory requirements, and dependency integrity rules, such that remediation actions balance fault recovery effectiveness with system-wide safety.

8. The method of claim 1, wherein the step of transmitting remediation commands comprises executing a secure dispatch protocol that initiates remediation actions in a staged manner, monitors execution success at intermediate checkpoints, applies rollback procedures when adverse effects are detected, and triggers secondary remediation cascades when initial remediation attempts fail to restore system stability.

9. The method of claim 1, wherein the step of observing updated telemetry data comprises detecting discrepancies between predicted remediation outcomes and observed system responses, and computing remediation accuracy values that quantify deviation magnitude, deviation duration, and performance stabilization time, such that the system evaluates effectiveness of remediation actions under varying workload, latency, and interference conditions.

10. The method of claim 1, wherein the step of determining long term reward values comprises computing remediation stability metrics based on recurrence intervals, cross-service propagation frequency, and post-remediation resource consumption, and adjusting policy representations to reduce reliance on remediation actions that produce temporary stabilization but lead to long term performance degradation or increased probability of cascading failures.

11. The method of claim 1, wherein the step of executing distributed inference operations by the plurality of autonomous reasoning agents comprises, for each autonomous reasoning agent, generating an internal belief state representation that encodes hypothesis confidence values, evidentiary provenance identifiers, and temporal support ranges, and iteratively updating said belief state representation in response to incoming inter-agent messages that include partial belief deltas, contradiction indicators, and convergence likelihood estimates received through asynchronous message exchange channels, and wherein the step of executing distributed inference operations further comprises computing, by each autonomous reasoning agent, hypothesis prioritization scores based on a combination of belief uncertainty magnitude, causal graph traversal depth, and estimated remediation impact radius, and allocating local computational resources preferentially to hypotheses exhibiting both high uncertainty and high potential impact on downstream services, while deprioritizing hypotheses associated with localized or previously resolved fault patterns.

12. The method of claim 1, wherein the step of executing distributed inference operations further comprises detecting, by the multi-agent inference processor, inter-agent hypothesis conflicts by comparing belief state representations received from different autonomous reasoning agents, classifying detected conflicts based on temporal disagreement, dependency disagreement, or evidentiary sufficiency disagreement, and applying conflict resolution rules that selectively request additional telemetry acquisition, defer hypothesis acceptance, or initiate targeted belief reconciliation exchanges among a subset of the autonomous reasoning agents associated with the conflicting hypotheses, and wherein the step of updating stored causal relationships comprises performing, by the causal knowledge representation unit, fine-grained edge adjustment operations on a causal dependency graph by incrementally modifying causal strength values, temporal lag parameters, and propagation likelihoods based on quantified alignment between predicted causal outcomes and observed telemetry responses following remediation execution, and wherein causal edges exhibiting persistent misalignment across multiple inference cycles are demoted or temporarily disabled from active inference participation; and wherein the step of updating stored causal relationships further comprises maintaining versioned causal graph snapshots that record historical states of causal dependencies along with associated confidence decay functions, and selectively reverting portions of the causal dependency graph to prior versions when detected remediation outcomes contradict recent causal updates beyond an acceptable deviation threshold.

13. The method of claim 1, wherein the step of adapting policy representations associated with the autonomous reasoning agents comprises computing, by the distributed reinforcement learning processor, composite reward vectors that integrate short-term diagnostic accuracy signals with long-horizon stability indicators derived from post-remediation telemetry trends, and updating agent policy parameters using said composite reward vectors in a manner that explicitly balances exploration of alternative causal explanations against exploitation of previously validated diagnostic strategies, and wherein the step of adapting policy representations further comprises coordinating, by the distributed reinforcement learning processor, inter-agent policy alignment operations in which policy update summaries, gradient contribution indicators, and uncertainty estimates are exchanged among autonomous reasoning agents, and wherein policy synchronization is selectively applied only to policy components associated with shared dependency domains to avoid homogenization of localized diagnostic expertise.

14. The method of claim 1, wherein the step of generating one or more remediation commands comprises decomposing, by the actuation control unit, each validated causal hypothesis into a sequence of ordered remediation primitives corresponding to service control actions, resource reallocation actions, and configuration modification actions, and assembling said remediation primitives into execution plans that respect inter-service dependency constraints, rollback feasibility conditions, and temporal coordination requirements derived from the causal knowledge representation unit, and wherein the step of generating one or more remediation commands further comprises evaluating, for each execution plan, predicted interference effects with concurrently executing remediation plans and scheduled operational activities, and conditionally serializing, parallelizing, or deferring remediation primitives based on predicted contention, execution overlap, and cumulative risk assessment values.

15. The method of claim 1, wherein the step of transmitting the one or more remediation commands comprises issuing, by the actuation control unit, execution acknowledgements and progress signals for individual remediation primitives, continuously correlating received execution feedback with expected causal effect timelines stored in the causal knowledge representation unit, and interrupting or modifying in-progress remediation execution when observed system responses diverge from predicted causal trajectories beyond a predefined tolerance range, and wherein the step of observing updated telemetry data further comprises computing, by the telemetry acquisition unit, post-remediation causal validation datasets that isolate telemetry changes attributable to remediation actions from telemetry changes caused by concurrent workload variation, background noise, or unrelated system events, and providing said causal validation datasets as structured inputs to subsequent inference and policy adaptation cycles, and wherein the step of determining long term reward values comprises aggregating, by the distributed reinforcement learning processor, multi-cycle remediation outcome histories that encode fault recurrence intervals, cross-component fault propagation patterns, and remediation-induced performance side effects, and adjusting future policy representations to progressively reduce selection probability of remediation strategies associated with unstable or transient recovery behavior across heterogeneous operating conditions.
